(19) United States
(12) Patent Application Publication
(10) Pub. No.: US 2005/0083010 A1
(43) Pub. Date: Apr. 21, 2005

(54) Portable electronic device with storage

(76) Inventor: Steven S. Homer, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/687,171

(22) Filed: Oct. 16, 2003

(51) Int. Cl. H02J 7/00

(52) U.S. Cl. 320/107

(57) ABSTRACT

An electronic device is formed with a removable battery module. The electronic device has a housing with a battery module bay for receiving various battery modules. At least one of the battery modules comprises a storage compartment.

### BACKGROUND OF THE INVENTION

A variety of electronic devices are designed as portable devices that can readily be transported by a user. For example, portable computers are routinely transported by the user from, for example, one business location to another. Because of this ease of portability, many portable computer users no longer rely on conventional portfolios for notepads, calendars, appointment books, etc. However, personal computers and other portable electronic devices do not readily provide storage areas for storing items that might otherwise accompany a conventional portfolio.

### BRIEF DESCRIPTION OF THE DRAWINGS

Certain embodiments of the invention will hereafter be described with reference to the accompanying drawings, wherein like reference numerals denote like elements, and:

FIG. 1 is a perspective view of an electronic device, according to an embodiment of the present invention;

FIG. 2 is a bottom view of an embodiment of the electronic device of FIG. 1;

FIG. 3 is a bottom view of an embodiment of a battery module that can be utilized with the device illustrated in FIG. 1;

FIG. 4 is another embodiment of the battery module illustrated in FIG. 3; and

FIG. 5 is another embodiment of the battery module illustrated in FIG. 4.

### DETAILED DESCRIPTION

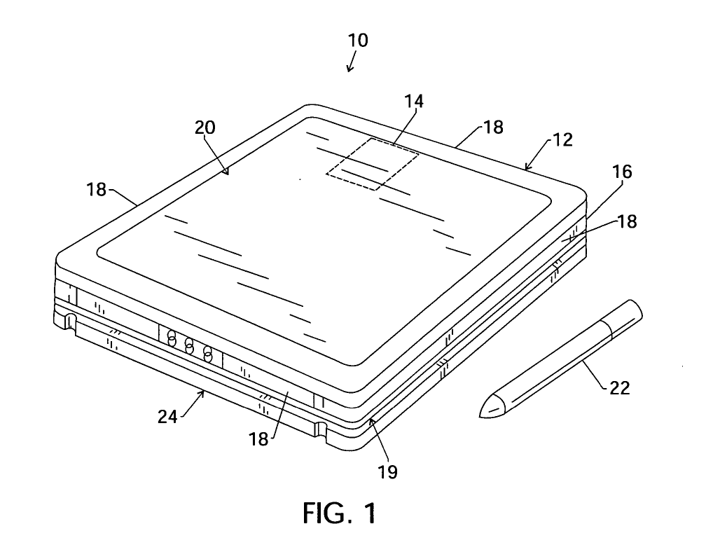

Referring generally to FIG. 1, an electronic device 10 is illustrated according to an embodiment of the present invention. The electronic device 10 is provided as an example to facilitate understanding of the present invention; however, a variety of electronic devices may be utilized.

In the embodiment illustrated in FIG. 1, electronic device 10 comprises a portable computer 12, such as a tablet personal computer (tablet PC). The computer 12 comprises a controller 14, such as a microprocessor. A housing 16 encloses controller 14 and has a perimeter edge 18 as well as a base wall 19. A display 20 is electrically coupled to the controller 14 and is adapted to display visual information to a user. In the embodiment illustrated, display 20 is mounted in housing 16 and extends outwardly toward perimeter edge 18.

Portable computer 12 may comprise a variety of other features and devices, such as a pointer mechanism 22 and a keyboard 24. Pointer mechanism 22 may be used to write or draw against display 20 to interact with, for example, a graphical user interface. Additionally, keyboard 24 may be a detachable keyboard that also permits an individual to provide input relative to information on display 20.

The illustrated tablet PC is one example of a portable computer that can accompany a user from one location to another location. The tablet PC design provides a portable, easy-to-grasp form factor having an integral display and internal controller. The relatively small, graspable form factor makes the tablet PC amenable to use in many and varied environments.

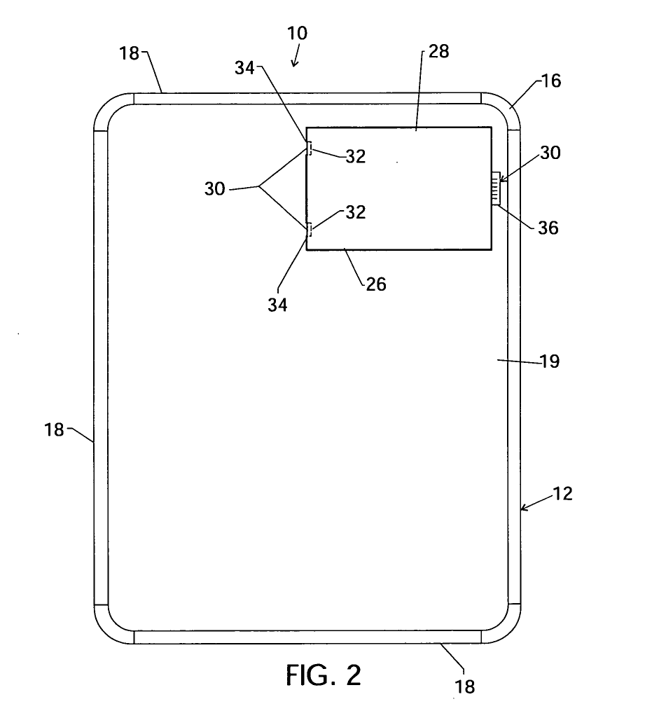

Referring generally to FIG. 2, electronic device 10 comprises a battery bay 26 formed in housing 16. For example, battery bay 26 may be formed as a recessed area in base wall 19. A battery module 28 is sized for insertion into battery bay 26.

Battery module 28 may be selectively maintained within battery bay 26 by a variety of retention mechanisms 30. For example, retention mechanisms 30 may comprise a variety of features that releasably hold battery module 28 within battery bay 26 until a user decides to remove or interchange the battery module. In one embodiment, retention mechanisms 30 comprise tabs 32 formed on base wall 19 for insertion into corresponding openings 34 formed in battery module 28. Additionally, a latch mechanism 36 may be used to selectively hold tabs 32 and openings 34 in an engaged position. This embodiment illustrates one of the numerous types of retention mechanisms 30 that may be utilized to selectively secure battery module 28.

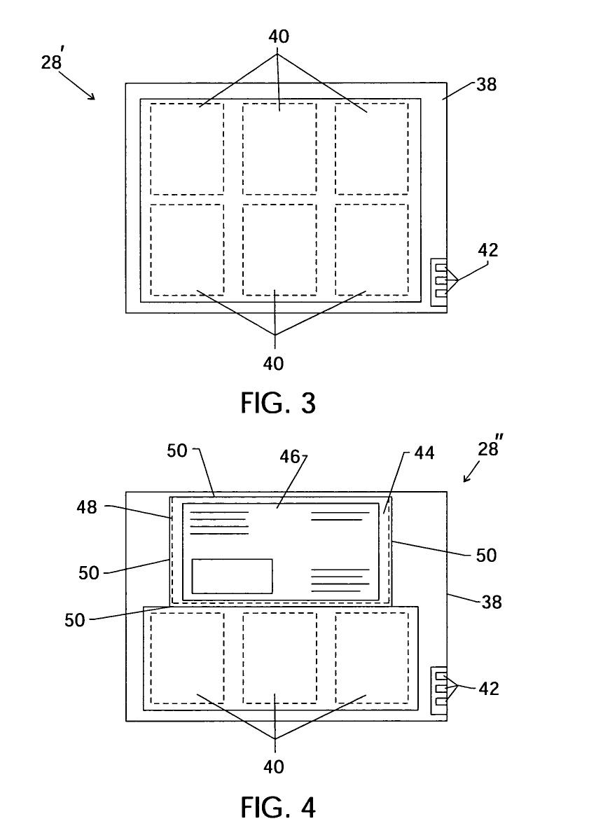

As further illustrated in FIGS. 3 and 4, battery module 28 generally comprises a housing 38 enclosing a plurality of battery cells 40. Battery cells 40 are electrically coupled to electrical contacts 42. Power is delivered from battery cells 40 to other ancillary components of electronic device 10 via appropriate contacts 42.

In the embodiment illustrated in FIG. 3, battery module 28′ has a housing 38 substantially filled with battery cells 40 to store energy for the computer. For many applications, however, such power storage capabilities are not required. Accordingly, an alternate battery module 28″ comprises a smaller number of cells 40, as illustrated in FIG. 4. The battery module 28′, illustrated in FIG. 3, and the battery module 28″, illustrated in FIG. 4, have comparable external dimensions and can be interchanged depending on the power storage requirements of a given portable computer or application. By way of example, the battery module designed for greater energy storage may comprise six batteries or battery cells 40 (as shown in FIG. 3), while the battery module designed with fewer cells may comprise three batteries or battery cells 40 (as shown in FIG. 4). The number and arrangement of battery cells 40, however, will vary according to the design of device 10 as well as the anticipated usage.

In the embodiment of FIG. 4, a storage compartment 44 has been created within housing 38. Storage compartment 44 may be designed to hold specific items often carried by, for example, a portable computer user. In the example illustrated in FIG. 4, for example, storage compartment 44 is sized for placement of a stack of business cards 46. However, compartment 44 may be designed to hold a variety of other items or combinations of items.

By way of example, storage compartment 44 may be formed as a recessed compartment enclosed by a cover 48, represented by the dashed line in FIG. 4. Cover 48 may be opened or removed to allow the user to selectively access and enclose storage compartment 44. Additionally, storage compartment 44 may be formed in a variety of shapes, such as a rectangular shape having perimeter walls 50 formed along an interior of the recessed compartment.

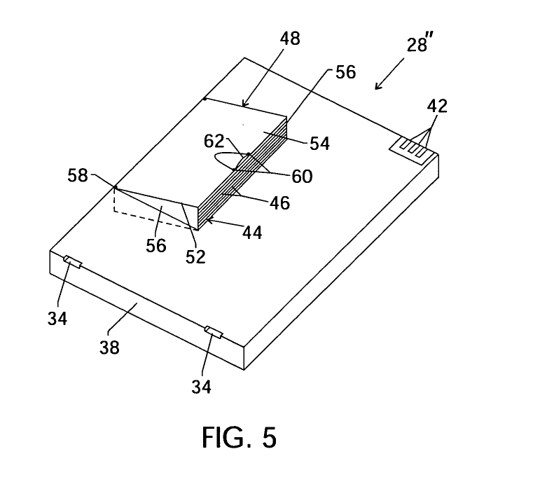

In an embodiment illustrated in FIG. 5, cover 48 is formed as a pivotable door 52 having a top portion 54 and a pair of sides 56. Door 52 is pivotably mounted to housing 38 by at least one pivot 58 to permit pivotable motion between a closed and an open position. Additionally, a latching mechanism 60, such as at least one interfering detent, is provided to hold door 52 in a closed position. A finger grip 62 also may be incorporated into door 52 to facilitate movement of door 52 to an opened position.

The combined use of a storage compartment and battery cells in the battery cell module provides a user with storage space for storing items, such as business cards or other items. However, the size and design of battery bay 26 enables the interchanging of other battery modules if, for example, a greater energy storage capability is desired. As illustrated, a six-cell battery module can be interchanged with a three-cell battery module to provide additional stored energy. Substitution of the battery module having storage compartment 44, however, provides the user with additional space for storing desired items. Such substitution also can reduce the weight of the overall electronic device 10.

While the invention may be susceptible to various modifications and alternative forms, specific embodiments have been shown by way of example in the drawings and described in detail herein. However, it should be understood that the invention is not intended to be limited to the particular forms disclosed.

1. A portable computer, comprising:
a housing having a battery bay; and
a battery module adapted to removeably fit into the battery bay, wherein the battery module comprises at least one battery cell adapted to provide power and at least one storage compartment located adjacent the battery cell.

2. The portable computer as recited in claim 1, wherein the battery module comprises three separate batteries.

3. The portable computer as recited in claim 2, wherein the three battery cells are electrically coupled to an electrical contact, wherein the electrical contact is adapted to connect to an ancillary electronic device.

4. The portable computer as recited in claim 2, wherein the storage compartment is formed as a recess in the battery module.

5. The portable computer as recited in claim 4, wherein the storage compartment has a rectangular shape.

6. The portable computer as recited in claim 5, wherein the storage compartment is sized to hold a plurality of business cards.

7. The portable computer as recited in claim 1, wherein the battery module comprises a cover adapted to provide access to the storage compartment.

8. A method, comprising the acts of:
providing a portable computer with a battery bay;
providing a battery module having a battery and a storage compartment; and
inserting the battery module into the battery bay.

9. The method as recited in claim 8, comprising the act of interchanging the battery module with a second battery module having additional battery cells in lieu of the storage compartment.

10. The method as recited in claim 8, wherein the battery comprises three battery cells located adjacent the storage compartment.

11. The method as recited in claim 9, wherein the act of interchanging comprises the act of interchanging the battery module with the second battery module having at least six cells.

12. The method as recited in claim 12, comprising the act of enclosing the storage compartment with a pivotable cover operable between open and closed positions.

13. The method as recited in claim 8, wherein the battery bay is located in a bottom region of the portable computer.

14. An electronic device, comprising:
a housing;
a battery bay formed in the housing;
a module removeably coupled to the battery bay, the module comprising a battery cell and a storage compartment adjacent the battery cell.

15. The device as recited in claim 14, wherein the battery is configured to accept at least three battery cells.

16. The device as recited in claim 14, wherein the storage compartment comprises a cover to selectively enclose the storage compartment.

17. The device as recited in claim 16, wherein the cover is pivotable between an opened position and a closed position.

18. The device as recited in claim 14, wherein the storage compartment is sized to hold a plurality of business cards.
